(19) United States
(12) Patent Application Publication
(10) Pub. No.: US 2009/0089434 A1
(43) Pub. Date: Apr. 2, 2009

(54) METHOD AND SYSTEM FOR SAVING AND RETRIEVING CLIENT-SPECIFIC INFORMATION IN AN INTERNET PROTOCOL MULTIMEDIA SUBSYSTEM

(76) Inventors: THOMAS E. CREAMER, Boca Raton, FL (US); Neil A. Katz, Parkland, FL (US); Joseph H. McIntyre, Round Rock, TX (US); Victor S. Moore, Lake City, FL (US)

Correspondence Address: DILLON & YUDELL LLP, 8911 N. CAPITAL OF TEXAS HWY., SUITE 2110, AUSTIN, TX, 78759, US

(21) Appl. No.: 11/864,518

(22) Filed: Sep. 28, 2007

(51) Int. Cl. G06F 15/16

(52) U.S. Cl. 709/227

(57) ABSTRACT

A method of saving and retrieving client-specific information in an Internet Protocol (IP) Multimedia Subsystem (IMS). A Serving Call Session Control Server (S-CSCF) receives information from a first client initiating a call to a second client. The information includes identification information corresponding to the first client and a Session Initiation Protocol (SIP) invite to the second client. If a profile of the first client in a Home Subscriber Server (HSS) includes a trigger value, the S-CSCF forwards the SIP invite to an Application Server (AS). If a local AS archive does not include valid profile information corresponding to the first client, the AS fetches valid profile information from the HSS, and the AS stores the profile information in the local archive. The AS sends the profile information corresponding to the first client from the local archive to the second client by embedding the profile information within the SIP invite.

### BACKGROUND OF THE INVENTION

The present invention relates in general to telecommunications networks and in particular to an Internet Protocol (IP) Multimedia Subsystem (IMS).

An IMS is a telecommunications framework that enables multiple clients (i.e., users) to exchange multimedia data using various networking protocols, such as the Session Initiation Protocol (SIP) and the DIAMETER protocol. An IMS typically includes a service layer and a common horizontal control layer that provides control functions to the service layer. An IMS also includes a Home Subscriber Server (HSS), which is a database that includes profile information corresponding to different clients and network devices. The HSS also performs Authentication, Authorization, and Accounting (AAA) functions.

Different SIP servers and/or proxies within an IMS use Call Session Control Functions (CSCFs) to process SIP data packets. For example, a Proxy-CSCF (P-CSCF) acts as the first point of contact for an IMS terminal. Similarly, a Serving-CSCF (S-CSCF) is a SIP server that acts as a central node in the IMS signaling plane. An Application Server (AS) hosts and executes one or more services that use client data. A S-CSCF does not store client information locally, but instead uses a DIAMETER Cx interface to communicate with the HSS to download and/or upload client data. Customer services, such as help desks and customer support centers, often require access to read and/or update previously-stored client data.

### SUMMARY OF AN EMBODIMENT

Disclosed are a method, system, and computer storage medium for saving and retrieving client-specific information in an Internet Protocol (IP) Multimedia Subsystem (IMS). A Serving Call Session Control Server (S-CSCF) receives information from a first client initiating a call to a second client. The information includes identification information corresponding to the first client and a Session Initiation Protocol (SIP) invite from the first client to the second client. If a profile of the first client in the Home Subscriber Server (HSS) includes a trigger value, the HSS forwards the SIP invite to an Application Server (AS). If a local archive in the AS does not include valid profile information corresponding to the first client, the AS fetches valid profile information from the HSS, and the AS stores the profile information in the local archive. The AS sends the profile information corresponding to the first client from the local archive to the second client by embedding the profile information within the SIP invite.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary Internet Protocol (IP) Multimedia Subsystem (IMS), according to an embodiment of the present invention; and

FIG. 2 is a high level logical flowchart of an exemplary method of saving and retrieving client-specific information in an internet protocol multimedia subsystem, according to an embodiment of the invention.

### DETAILED DESCRIPTION OF AN ILLUSTRATIVE EMBODIMENT

The present invention provides a method, system, and computer storage medium for saving and retrieving client-specific information in an Internet Protocol (IP) Multimedia Subsystem (IMS).

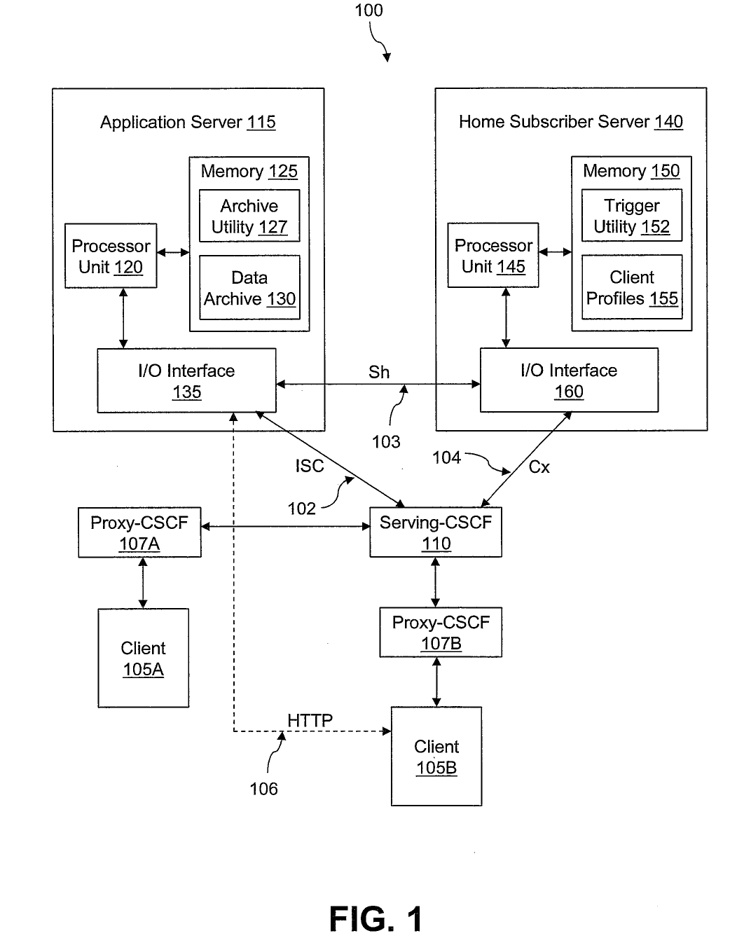

With reference now to FIG. 1, there is depicted a high level block diagram of an exemplary IMS, according to an embodiment of the present invention. As shown, IMS 100 includes multiple clients 105A and 105B, an Application Server (AS) 115, and a Home Subscriber Server (HSS) 140. IMS 100 also includes a first Proxy Call Session Control Function (P-CSCF) 107A, which is connected to client 105A, and a second P-CSCF 107B, which is connected to client 105B. P-CSCFs 107A and 107B are each coupled to a Serving Call Session Control Function (S-CSCF) 110. S-CSCF 110 is in turn coupled to AS 115 and HSS 140.

In one embodiment, AS 115 includes a processor unit 120, a memory 125, and an Input/Output (I/O) interface 135. Memory 125 and I/O interface 135 are coupled to processor unit 120. Memory 125 includes a data archive 130 and an archive utility 127, which manages data archive 130 by storing new data entries corresponding to clients of IMS 100 (e.g., clients 105A and 105B), updating existing entries, and/or retrieving data.

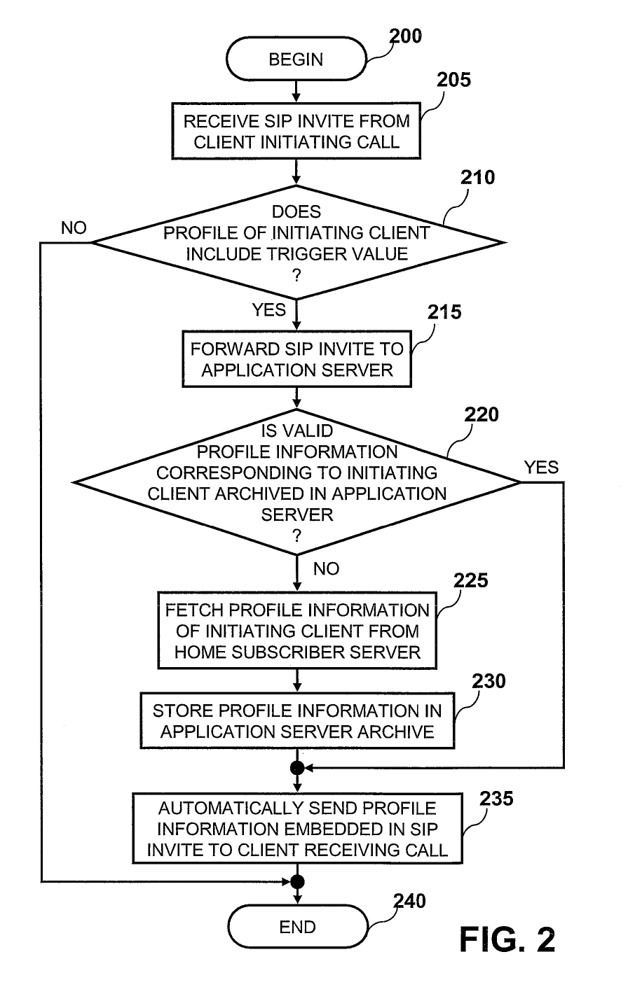

According to the illustrative embodiment, AS 115 and HSS 140 are configured similarly. HSS 140 thus includes a processor unit 145, a memory 150, and an I/O interface 160. Memory 150 includes a trigger utility 152 and one or more client profiles 155 that include detailed information corresponding to clients of EMS 100, such as clients 105A and 105B. Archive utility 127 and trigger utility 152 perform the functions illustrated in FIG. 2, which is described below.

In one embodiment, S-CSCF 110 is coupled to I/O interface 135 of AS 115 via a network cable 102, and S-CSCF 110 communicates with AS 115 using an IMS Service Control (ISC) interface. As utilized herein, an ISC interface refers to data communications between a S-CSCF and a HSS that may be defined by the Session Initiation Protocol (SIP). S-CSCF 110 is also coupled to I/O interface 160 of HSS 140 via a network cable 104, and S-CSCF 110 communicates with HSS 140 using a Cx Interface. As utilized herein, a Cx interface refers to data communications between a S-CSCF and a HSS that may be defined by the DIAMETER protocol. The DIAMETER protocol is a networking protocol for the exchange of information in a reliable manner, with the ability to define data to be exchanged. DIAMETER may be used for Authentication, Authorization, and Accounting (AAA) functionality, access to data stored in HSS 140, and/or for other purposes. Similarly, AS 115 is coupled to HSS 140 via network cable 103, and AS 115 communicates with HSS 140 using a Sh interface. As utilized herein, a Sh interface refers to data communications between an AS and a HSS that may be defined by the DIAMETER protocol.

In an alternate embodiment, AS 115 may be directly coupled to a client, such as client 105B, via a network connection 106, and AS 115 may thus communicate with client 105B using HyperText Transfer Protocol (HTTP). Client 105B may thus receive information from client 105A via AS 115 in using HTTP, and/or using SIP via P-CSCF 107B and S-CSCF 110.

With reference now to FIG. 2, there is illustrated a high level logical flowchart of an exemplary method of saving and retrieving client-specific information in an IMS according to an embodiment of the invention. The process begins at block 200 in response to a first client, such as client 105A (FIG. 1), initiating a call to a second client, such as client 105B. HSS 140 receives an SIP invite via S-CSCF 110 from the client that initiated the call (i.e., the initiating client), as depicted in block 205. As utilized herein, an SIP invite refers to a SIP signal sent by an initiating client, such as client 105A, to another client, such as client 105B, that acts as a request to initiate a call.

At block 210, trigger utility 152 accesses client profiles 155 and determines whether or not the profile of the initiating client includes a user-defined trigger value. If the profile of the initiating client does not include a pre-defined trigger value, the process terminates at block 240, and the call proceeds normally (i.e., the client receiving the call does not automatically receive profile information corresponding to the initiating client during the call).

If the profile of the initiating client (e.g., client 105A) includes a user-defined trigger value, trigger utility 152 forwards the SIP invite to AS 115 via network cable 103, as shown in block 215. At block 220, archive utility 127 determines whether or not data archive 130 in AS 115 includes valid (i.e., up-to-date) profile information corresponding to the initiating client. If data archive 130 includes valid profile information that corresponds to the initiating client, the process proceeds to block 235. If data archive 130 does not include valid profile information that corresponds to the initiating client, archive utility 127 fetches profile information from HSS 140, as depicted in block 225. Archive utility 127 subsequently stores the new and/or updated profile information locally in data archive 130, as shown in block 230. As utilized herein, profile information refers to detailed information that corresponds to a particular client, including, but not limited to, the name, phone number, address, business title (e.g., Vice President), and organizational department (e.g., Finance) of the client.

At block 235, archive utility 127 automatically sends profile information corresponding to the initiating client to the client that is receiving the call (e.g., client 105B) by embedding the profile information within the SIP invite. The process subsequently terminates at block 240, and the call proceeds normally (i.e., clients 105A and 105B communicate via IMS 100). In another embodiment, archive utility 127 may not embed the profile information within the invite, but may instead send the profile information directly to client 105B using HTTP via network connection 106.

The present invention thus provides a method of saving and retrieving client-specific information in an IMS. S-CSCF 110 (FIG. 1) receives information from a first client (e.g., client 105A) initiating a call to a second client (e.g., client 105B). The information includes identification information corresponding to the first client and a Session Initiation Protocol (SIP) invite from the first client to the second client. If a profile of the first client in HSS 140 includes a trigger value, HSS 140 forwards the SIP invite to AS 115. If local data archive 130 in AS 115 does not include valid profile information corresponding to the first client, AS 115 fetches valid profile information from HSS 140, and AS 115 stores the profile information in local data archive 130. AS 115 sends the profile information corresponding to the first client from local data archive 130 to the second client by embedding the profile information within the SIP invite.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 2) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional telecommunications system with installed software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a telecommunication network, a method comprising:
receiving information from a first client initiating a call to a second client, wherein said information includes identification information corresponding to said first client and a Session Initiation Protocol (SIP) invite from said first client to said second client;
in response to a determination that a profile of said first client stored in a Home Subscriber Server (HSS) includes a trigger value:
forwarding said SIP invite to an Application Server (AS);
in response to a determination that a local archive in said AS does not include valid profile information corresponding to said first client:
fetching said valid profile information corresponding to said first client from said HSS; and
storing said valid profile information corresponding to said first client in said local archive; and
sending said valid profile information corresponding to said first client from said local archive to said second client, wherein said valid profile information is embedded within said SIP invite.

2. The method of claim 1, wherein sending said valid profile information further comprises sending said valid profile information directly to said second client using a HyperText Transfer Protocol (HTTP) network connection.

3. A telecommunication system comprising:
a plurality of Proxy Call Session Control Functions (P-CSCFs);
a Serving Call Session Control Function (S-CSCF) coupled to said plurality of P-CSCFs;
a Home Subscriber Server (HSS) coupled to said S-CSCF, wherein said HSS comprises:
a first processor unit;
a first Input/Output (I/O) interface coupled to said first processor unit; and
a first memory coupled to said first processor unit, wherein said first memory includes:
a plurality of client profiles; and
a trigger utility that provides means for receiving information from a first client initiating a call to a second client, wherein said information includes identification information corresponding to said first client and a Session Initiation Protocol (SIP) invite from said first client to said second client; and
an Application Server (AS) coupled to said S-CSCF and said HSS, wherein said AS comprises:
a second processor unit;
a second I/O interface coupled to said second processor unit; and
a second memory coupled to said second processor unit, wherein said second memory includes:
a local archive; and
an archive utility that provides means for:
fetching said valid profile information corresponding to said first client from said HSS when said local archive does not include valid profile information corresponding to said first client; and
storing said valid profile information corresponding to said first client in said local archive; and
sending said valid profile information corresponding to said first client from said local archive to said second client, wherein said valid profile information is embedded within said SIP invite when the profile of said first client includes a trigger value.

4. The telecommunication system of claim 3, wherein said means for sending said valid profile information to said second client farther comprises means for sending said valid profile information directly to said second client using a HyperText Transfer Protocol (HTTP) network connection.

5. A computer storage medium encoded with a computer program that, when executed, performs the steps of:
receiving information from a first client initiating a call to a second client, wherein said information includes identification information corresponding to said first client and a Session Initiation Protocol (SIP) invite from said first client to said second client;
in response to a determination that a profile of said first client stored in a Home Subscriber Server (HSS) includes a trigger value:
forwarding said SIP invite to an Application Server (AS);
in response to a determination that a local archive in said AS does not include valid profile information corresponding to said first client:
fetching said valid profile information corresponding to said first client from said HSS; and
storing said valid profile information corresponding to said first client in said local archive; and
sending said valid profile information corresponding to said first client from said local archive to said second client, wherein said valid profile information is embedded within said SIP invite.

6. The computer storage medium of claim 5, wherein said code for sending said valid profile information further comprises code for sending said valid profile information directly to said second client using a HyperText Transfer Protocol (HTTP) network connection.
